(19) United States
(12) Patent Application Publication
(10) Pub. No.: US 2011/0177487 A1
(43) Pub. Date: Jul. 21, 2011

(54) METHODS AND APPARATUS FOR PERFUSION OF AN EXPLANTED DONOR HEART

(75) Inventors: Sinan Simsir, Mendham, NJ (US); Jason Wook Lee, New York, NY (US); Lawrence Czer, Santa Monica, CA (US); Alfredo Trento, Malibu, CA (US)

(73) Assignee: CEDARS-SINAI MEDICAL CENTER, Los Angeles, CA (US)

(21) Appl. No.: 13/120,420

(22) PCT Filed: Sep. 23, 2009
(86) PCT No.: PCT/US09/58076

§ 371 Date: Mar. 22, 2011

Related U.S. Application Data
(60) Provisional application No. 61/099,493, filed on Sep. 23, 2008.

(51) Int. Cl. A01N 1/02

(52) U.S. Cl. 435/1.2; 435/284.1

(57) ABSTRACT

Described herein are methods and apparatus that may be used in various applications, such as to extend the viability of a donor heart, promote the efficacy for transportation of a donor heart, and/or reduce costs associated with donor heart transport and preservation. In one embodiment, the subject matter discloses an effective method and apparatus for comprehensive cold perfusion of an explanted donor heart for improved preservation.

### FIELD OF THE SUBJECT MATTER

The present subject matter relates to methods and apparatus for preservation of explanted donor organs. More specifically, the present subject matter relates to a method and apparatus for perfusion and cooling of an explanted donor heart for improved organ preservation.

### BACKGROUND OF THE SUBJECT MATTER

All publications herein are incorporated by reference to the same extent as if each individual publication or patent application was specifically and individually indicated to be incorporated by reference. The following description includes information that may be useful in understanding the present subject matter. It is not an admission that any of the information provided herein is prior art or relevant to the presently claimed subject matter, or that any publication specifically or implicitly referenced is prior art.

Successful human organ and tissue transplants have a relatively long history, with the first account of a transplant in the 16^{th} century, when Roman Catholic saints, Cosmas and Damian, miraculously transplanted the gangrenous (white) leg of the Roman deacon Justinian with the leg of a recently deceased Ethiopian (black) leg. Several other accounts of transplants exist well prior to the scientific understanding and advancements that would be necessary for them to have actually occurred. For example, the Chinese physician Pien Chi'ao reportedly exchanged hearts between a man of strong spirit but weak will with one of a man of weak spirit but strong will in an attempt to achieve balance in each man.

The first attempted human deceased-donor transplant was performed by the Ukrainian surgeon Yu Yu Voronoy in the 1930s, which lead to failure due to rejection. Joseph Murray performed the first successful deceased-donor transplant, a kidney transplant between identical twins, in 1954; successful because no immunosuppression was necessary in genetically identical twins.

As successful organ transplants increased, the heart became the next major prize for transplant surgeons. But as well as presenting rejection issues, which could now be addressed by the recent advent of immunosuppressants, the heart presented deterioration issues. The first successful heart transplant occurred on December 3rd 1967, by Christiaan Barnard in Cape Town, South Africa. The recipient of the heart, Louis Washkansky, survived for eighteen days. The interest in heart transplants and fame associated with the procedure lead to over a hundred attempts made between 1968-69, with almost all the patients dying within sixty days. The first viable heart transplant was completed in Chritiaan Barnard's second attempt, which lived for 19 months.

With organ transplants becoming commonplace, limited only by donors, surgeons moved onto more risky fields, like multiple organ transplants on humans and whole-body transplant research on animals.

In recent decades, doctors expanded their knowledge of successful transplant techniques to include other or multiple organs, and dramatically improved recovery rates with the help of acceptable immunosuppressant's. Today, most organ transplants are relatively safe, routine procedures, and transplantation is considered to be the best treatment option for thousands of patients every year.

However, as the ability to carry out successful transplants has made this technology a feasible solution for thousands of transplant candidates, several hurdles have presented themselves in limiting organ transplants. A major constraint is the length of time that a donor organ will remain viable after it is harvested. As an example, the heart has a preferred viable interval of approximately four hours. Within the four hours, the donor heart must be removed, transported to the transplant surgery site, and functionally resettled within the recipient. In addition, other restraints may also place limitations on organ viability, including obtaining consent from the families of the potential donors prior to retrieval of the organ, the need to secure an operating room, as well as determining compatibility between the organ donor and recipient. Thus, current technology associated with heart transplants is viable only if the donor heart is transplanted rapidly.

Current methods and devices used for improving organ preservation and extending the viability time of the organ entail cooling the donor organ rapidly to minimize the deleterious effects of ischemia on the organ's microvasculature. For the heart, this is accomplished by a rapid flushing of the heart's microvasculature with cold solution, which results in the rapid cooling of the heart and removal of red blood cells from the microcirculation, followed by cessation of blood flow through the organ. By rapidly cooling the heart, the metabolism is greatly reduced, lowering the requirements for nutrients and oxygen, and greatly reducing the production of lactic acid and other toxic end products of metabolism. This rapid cooling of the heart further requires maintenance of cold temperature for a given period of time while the heart remains dormant or is in transit, as an appropriate recipient is selected and prepared to transplantation.

Further methods for heart preservation include the introduction of a perfusion solution (“perfusate”) to the heart. The perfusate replenishes the oxygen and nutrients available to the heart, and removes lactic acid and other toxic metabolites from the heart (this method is generally referred to as “perfusion”). Current perfusion methods incorporate a pump which is designed to propel the perfusate to the explanted heart. Commonly during perfusion, as the organ's vascular resistance increases, the perfusion pressure increases to maintain flow. Accordingly, one of the problems with current pump driven heart preservation methods is that they tend to damage the delicate microvasculature of the heart which, in turn, causes the microvasculature to resist the perfusate, aggrevating the replenishment goal of the perfusion method.

Additional methods for delivering perfusion solution to organs include trickle flow perfusate delivery systems. In addition to requiring the use of a pump to deliver perfusate to the heart, these trickle flow methods do not monitor or control the perfusate flow rate or pressure. Without such control, there is no way of determining whether the heart is being sufficiently perfused. In transport, the hypothermic isolated heart lacks the neurological awareness to protect itself by constricting its vasculature under high pressure conditions, or by dilating to open its capillaries to allow more flow. Thus, without a monitored control, these apparatuses may be providing perfusate to the heart at inadequate or undesirably high volumes and pressures. Accordingly, the trickle perfusate systems may also lead to ischemia of the heart or damage to the heart's microvasculature.

Alternative methods for heart preservation have incorporated a technique identified as “intermittent perfusion”, referring to the periodic interruption of static cold storage with session(s) of perfusion at various time(s), each session(s) of perfusion being maintained for a defined time at a defined perfusion pressure and at a defined temperature. Although studies have shown positive results when incorporating multiple sessions of intermittent perfusion of the heart during simple cold storage, intermittent perfusion is not definitive. Furthermore, intermittent perfusion suffers from the same inadequacies highlighted above, namely, inadequate or undesirably high volumes and pressures of perfusate, and a pump mechanism for driving the perfusate.

An additional alternative method for heart preservation is “microperfusion”, which incorporates continuous perfusion at very low flow rates to avoid the problems associated with continuous perfusion. However, this alternative also falls short, as microperfusion can induce endothelial damage, and may induce myocardial edema due to enhanced microvascular fluid filtration in the face of a cessation of lymphatic flow. Enhanced cell swelling due to the increased availability of water for cellular uptake may also reduce heart compliance, making the heart stiff, and impairing function. In addition, microperfusion lacks the flow rate necessary to penetrate perfusate into the microvasculature of the heart, hindering perfusion efficacy.

In addition to the deficiencies iterated above, current methods and devices for organ preservation require the use of a pump for delivery of the perfusate to the donor organ. The relatively large and cumbersome pump systems combined with a power source for operation of the pump system, seriously hinders the mobility and efficiency of transport for current organ preservation devices.

Further advancements in organ preservation have focused on combining the rapid cooling of organs with various perfusion methods. Different methods have been adopted to improve overall organ preservation, including improvements to the preservation solution itself, by experimenting with new formulations that improve cell viability (and thus overall organ viability), as well as developing computerized electrical pump systems to regulate and optimize organ perfusion. However, these systems are expensive and complex, requiring initial investments of up to $150,000 (Transmedic's system requires an initial capital investment of ˜$150,000 and $3,500 for each procurement; Organ Recovery Systems' require an initial capital investment of approximately $20,000 and $920 for each procurement). Furthermore, current heart preservation systems may require opening the cooling chamber and perfusion device for oxygenation of the perfusion liquid and manipulation of the perfusion mechanism, thus compromising the sterility of the system and increasing the possibility of contamination.

Accordingly, there remains a need in the art for a heart perfusion and transport method and apparatus that: 1) improves preservation of the explanted heart; 2) extends the duration of preservation for a transplanted heart; and 3) provides for a light weight portable, self-contained, apparatus for effortless transport of an explanted heart.

### SUMMARY OF THE DISCLOSURE

The present subject matter provides a method and apparatus for heart preservation and transportation. The method and apparatus may include a cold perfusion system for circulation of the preservation solution through the heart, utilizing a pressure vacuum system, as well as methods for using and optimizing the apparatus. The method and apparatus may further include a closed, sterile system for transportation of the organ and housing of the cold perfusion system. The method and apparatus may also include methods of using a preservation solution specialized to promote preservation of the heart.

Other features and advantages of the subject matter will become apparent from the following detailed description, which illustrates, by way of example, various embodiments of the present subject matter.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 depicts a heart preservation and transportation apparatus in accordance with an embodiment of the present subject matter.

FIG. 2 depicts a heart preservation and transportation apparatus fixed in an insulated container in accordance with an embodiment of the present subject matter.

### DETAILED DESCRIPTION OF THE SUBJECT MATTER

All references cited herein are incorporated by reference in their entirety as though fully set forth. Unless defined otherwise, technical and scientific terms used herein have the same meaning as commonly understood by one of ordinary skill in the art to which this subject matter belongs. Singleton et al., Dictionary of Microbiology and Molecular Biology 3^{rd} ed., J. Wiley & Sons (New York, N.Y. 2001); March, Advanced Organic Chemistry Reactions, Mechanisms and Structure 5^{th} ed., J. Wiley & Sons (New York, N.Y. 2001): and Sambrook and Russell, Molecular Cloning: A Laboratory Manual 3rd ed., Cold Spring Harbor Laboratory Press (Cold Spring Harbor, N.Y. 2001), provide one skilled in the art with a general guide to many of the terms used in the present application.

One skilled in the art will recognize many methods and materials similar or equivalent to those described herein, which could be used in the practice of the present subject matter. Indeed, the present subject matter is in no way limited to the methods and materials described. For purposes of the present subject matter, the following terms are defined below.

“Ischemia” as used herein refers to an absolute or relative shortage of the blood supply to an organ (i.e. a shortage of oxygen, glucose and other blood-borne fuels). The relative shortage results in tissue damage because of a lack of oxygen and nutrients. Ultimately, this can cause severe damage because of the potential for a build-up of metabolic wastes.

“Immunosuppression” as used herein refers to the suppression of the immune response, usually with medications, to prevent the rejection of a transplanted organ or tissue. Medications commonly used to suppress the immune system after transplantation include prednisone; prednisolone, methylprednisolone, azathioprine, mycophenalate mofetil, cyclosporine, tacrolimus, sirolimus, and antibodies developed to interfere with the function of the immune system itself.

“Donor Organ” refers to a harvested organ that has been removed from the host. A donor organ may include any transplantable organ of the body.

“Transplant” or various grammatical forms thereof, refer to the physical act of providing a patient with tissues from a living source distinct from the patient. The transplant can be either a primary graft or a regraft.

The present subject matter relates to a method and apparatus for organ preservation and transportation. More specifically, the present subject matter discloses a method and apparatus which extends the accepted time threshold for transplanting a donor heart, which greatly enhances the functionality of the donor heart, increases the pool of donor hearts available to a recipient, and allows for more comprehensive testing of organ and recipient compatibility. The present subject matter further reduces the rate of ischemia for any given donor heart, which in turn increases transplant success rate.

The methods of the present subject matter are based, in part, on the inventors' discovery of a technique for preserving the heart which permits comprehensive circulation of cold perfusion solution throughout critical portions and vessels of the donor heart for replenishing nutrients and oxygen and removing harmful toxins such as lactic acid, while the heart is housed at an optimal temperature. The technique is based upon the understanding that adjustable placement of the heart within the subject matter apparatus leads to the effective flow of perfuate through the heart, eliminating waste and deminishing ischemia.

The methods lead themselves to self-contained apparatus which are light, sterile and easily transportable, making them ideal for donor heart preservation and transport. The components of the apparatus and compatibility with existing medical devices, namely, pressure vacuum systems, allow the apparatus to function without the need of cumbersome pumps, power sources, and computerized equipment. In addition, attributes of the apparatus allow for disposable use or recycling, thus eliminating or reducing incidents of infection and/or contamination, and reducing costs associated with organ preservation and transport.

The methods and apparatus disclosed herein further improve donor heart function and reduce the rate of ischemia in the heart, leading to improved preservation of the explanted donor heart, as well as extending the duration of preservation for the transplanted heart, and providing for a light weight portable, self-contained, apparatus for effortless transport of an explanted heart.

### Apparatus

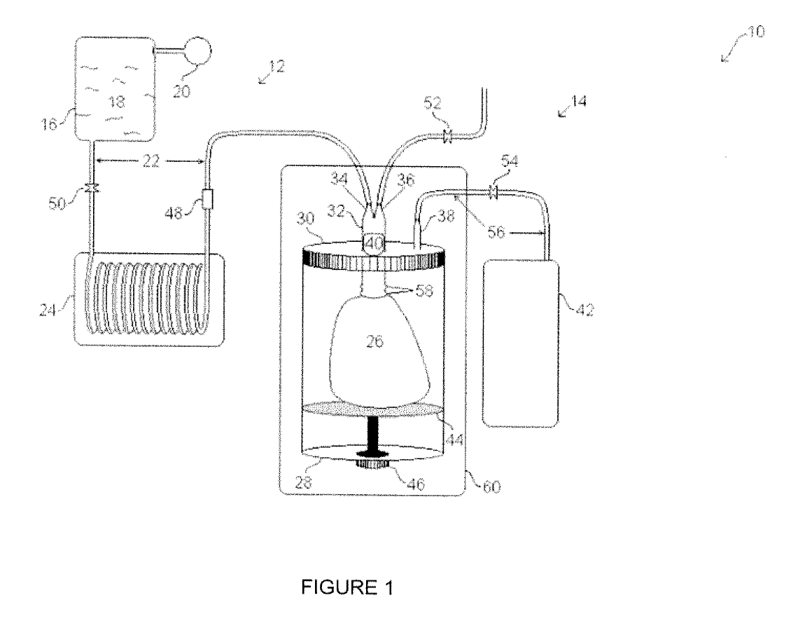

With reference to FIG. 1, in one embodiment of the present subject matter, the Cardioplegia apparatus 10 contains a perfusion system 12 and an organ compartment 14. The perfusion system 12 comprises a preservation solution source 16 containing preservation solution 18 and a pressure source 20 connected to the solution source 16 for providing the pressure needed to drive the preservation solution 18 throughout the Cardioplegia apparatus 10. The perfusion system 12 further comprises a cooling coil 24 connected via afferent tubing 22 to the solution source 16, for regulating the temperature of the preservation solution 18. The afferent tubing 22 is in communication with the organ compartment 14 at the perfusate port 34.

The organ compartment 14 houses the heart 26 and comprises an organ container 28 with a removable top 30, wherein the removable top 30 incorporates a cannula 32 containing multiple ports. The multiple ports of the cannula 32 include a perfusate port 34, and a de-airing port 36. The removable top 30 also contains an outlet port 38. The perfusate port 34 extends the length of the cannula 32 with the inferior end of the perfusate port 34 connecting to the heart 26 and the superior end of the perfusate port 34 connecting to the afferent tubing 22 leading to the cooling coil 24, for introducing preservation solution 18 to the heart 26. The de-airing port 36 extends from a de-airing chamber 40 found in the medial portion of the cannula 32, upwards beyond the superior end of the cannula 32, and functions to alleviate excess air from the perfusion system 12. The de-airing port allows air to be removed from the de-airing chamber 40 at the time of initial priming of the system as well as during transportation where new air bubbles can emerge in the Cardioplegia apparatus 10. The outlet port 38 extends into the container 28 and is connected to a waste bag 42 via efferent tubing 56. The outlet port 38 functions to remove waste preservation solution 18 from the container 28 and discards the waste preservation solution 18 in the waste port 42.

The organ compartment 28 also comprises an adjustable cradle 44 for supporting the donor organ 26, wherein the cradle 44 may be mechanically repositioned perpendicular to the cannula 32, via a repositioning device 46.

In another embodiment of the subject matter, the perfusion system 12 may incorporate a filter 48 in the afferent tubing 22 between the cooling coil 24 and the cannula 32 to limit the introduction of harmful substances (e.g., air bubbles, un-solublized additives) from the preservation solution 18 to the heart 26.

In yet another embodiment of the subject matter, the perfusion system 12 may incorporate the use of a clamping device 50 in the afferent tubing 22 between the preservation solution source 16 and the cooling coil 24, to control the flow of preservation solution 18 to the cooling coil 24.

In a further embodiment of the subject matter, the Cardioplegia apparatus 10 may incorporate the use of a clamping device 52 at the superior end of the de-airing port 36, to control and alleviate the flow of air in the de-airing chamber 40 and perfusion system 12.

In another embodiment of the subject matter, the organ compartment 14 may incorporate the use of a clamping device 54 in the efferent tubing 56 between the outlet port 38 and the waste bag 42, to control the flow of preservation solution 18 from the organ container 28 to the waste port 42.

With reference to FIG. 1, an alternative embodiment of the subject matter may incorporate the use of at least one flange 58 located at the inferior end of the cannula 32 for secure attachment of the heart 26 to the cannula 32.

In a further embodiment of the subject matter, the Cardioplegia apparatus 10 may incorporate the use of at least one sterile bag 60 encapsulating the organ compartment 14 for sterile transportation of the donor heart 26.

With reference to FIG. 1, the pressure source may comprise a pressure vacuum system.

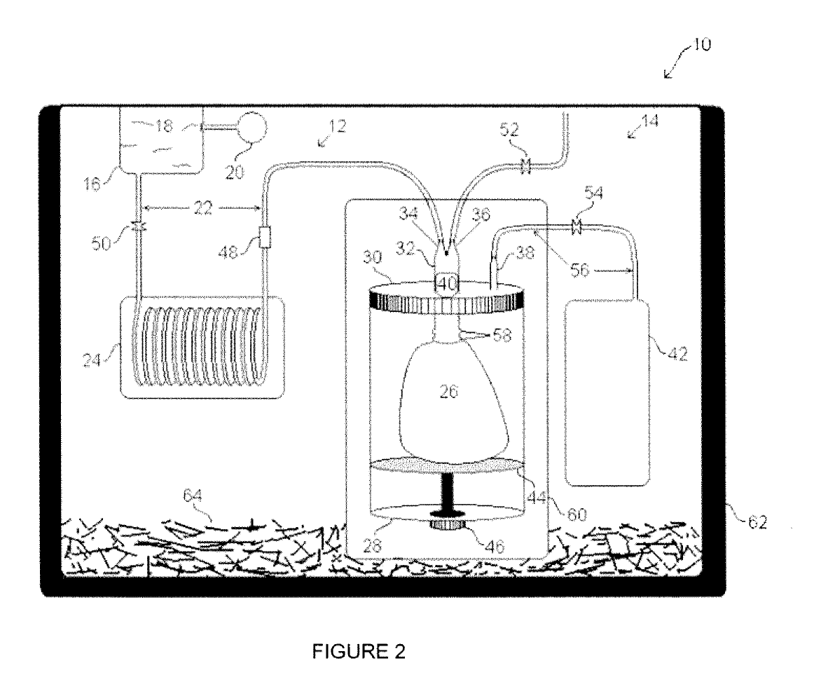

With reference to FIG. 2, in another embodiment of the subject matter, the Cardioplegia apparatus 10 may be housed in a larger insulated container 62 which may be filled with crushed ice or the like to help maintain the heart 26 at a constant temperature.

In yet another embodiment of the subject matter, the perfusion system 12 may incorporate the use of a pressure regulator to control the flow of preservation solution to the perfusion system.

In another embodiment of the subject matter, the perfusion system 12 may integrate the use of a one-way valve (not shown) found in the efferent tubing 56 between the outlet port 38 and the waste bag 42, to prevent the reflux of preservation solution 18 from the waste bag 42 to the organ container 28.

### Method

The subject matter method of heart transportation and preservation for heart transplantation comprises the assembly of the Cardioplegia apparatus, followed by priming the cooling coil with preservation solution using the solution source and pressure source. Once primed, the tubing to the cooling coil from the solution source is clamped to prevent run-off from the cooling coil. Preservation solution is added to the container in preparation for receiving the donor heart.

Once the donor heart is explanted and ready to be received into the Cardioplegia apparatus, the removable top of the container is opened and the heart is secured to the inferior end of the perfusate port. The organ must be secured tightly to the perfusate port for effective and optimal use of the Cardioplegia apparatus. The heart may be secured above the at least one flange located at the inferior end of the cannula. The removable top is attached to the container and the heart is situated in the adjustable cradle. The heart is visually inspected verifying that the heart is sufficiently extended when situated in the organ container and that the heart is slightly suspended to ensure competency of perfusate to critical portions and vessels of the heart. By adjusting the cradle one may ensure proper competency of the heart, thus promoting adequate flow of the preservation solution to critical portions of the heart.

Once the donor heart is secured to the cannula and properly adjusted in the cradle with the container sealed, the solution source clamp, initiating the flow of preservation solution to the heart through the perfusate port, is opened and the donor heart is flushed with preservation solution. To ensure proper flow of preservation solution without any trapped air, the de-airing port is opened, allowing air to bleed from the de-airing chamber. Once the desired amount of air has escaped through the de-airing chamber, the de-airing port is closed.

The container and donor heart are visually analyzed to ensure proper flow and propagation of the preservation solution to all portions of the heart. If the flow or amount of preservation solution to the heart requires adjustment, the preservation solution pressure and/or heart position may be manipulated to accomplish optimal perfusion rate. The Cardioplegia apparatus is placed into at least one sterile bag and sealed, ensuring all afferent clamps and efferent clamps are situated outside the sterile bag to allow for manipulation of the clamps without endangering the sterility of the Cradioplegia apparatus. The at least one sterile bag containing the Cardioplegia apparatus is placed into an icebox for transport, and ice is packed around the sterile bag as necessary. Prior to transport, the heart and Cardioplegia apparatus are examined to verify performance and ensure competency to critical portions and vessels of the heart.

In an embodiment of the present subject matter, the Cardioplegia apparatus may be intermittently operated to ensure adequate flow of preservation solution throughout the donor heart. This intermittent operation of the Cardioplegia apparatus may be accomplished with clamps and/or valves which are found outside the sterile bag and may be manipulated by an organ transporter or the like, without compromising sterility. The procedure for intermittent operation of the Cardioplegia apparatus may include: a) opening the efferent tubing clamp or valve connecting the outlet port to the waste bag, thus relieving pressure on the Cardioplegia system; b) opening the afferent tubing clamp or valve connecting the preservation solution source to the cooling coil, thus allowing preservation solution to enter and be cooled by the cooling coil; and c) initiating the pressure source to promote the flow of preservation solution through the Cardioplegia apparatus. Once adequate flow of preservation solution through the donor heart is accomplished, the Cardioplegia apparatus may be inactivated by the following steps: a) closing the afferent clamp or valve, eliminating the flow of preservation solution to the heart; b) closing the efferent clamp or valve, ensuring adequate amounts of preservation solution remain in the critical portions and vessels of the heart; and c) releasing pressure on the pressure source. The previously detailed steps of intermittent operation and inactivation may be repeated as necessary to ensure and/or extend organ preservation.

Alternatively, in activating the Cardiopleagia apparatus, the pressure source may be adjusted by a pressure valve, which may be fitted to the pressure source. In another embodiment the pressure source may be regulated by a seat valve, a ball valve, a stem valve, or other valves and similar mechanisms which are functionally analogous.

In yet another embodiment, the present subject matter is also directed at a kit intended for, but in no way limited to, (1) cold perfusion of a donor heart; (2) transportation of a donor heart, and/or (3) extended viability of a donor heart in transport. The kit is useful for practicing the inventive methods and using the apparatus disclosed herein. The kit is an assemblage of materials or components, including at least one of the inventive components. Thus, in some embodiments the kit contains a component including a perfusion system, organ compartment, preservation solution, and combinations thereof.

The kits may include instructions for use. “Instructions for use” typically include a tangible expression describing the technique to be employed in using the components of the kit to effect a desired outcome, such as to preserve and/or transport a donor heart.

The materials or components assembled in the kit can be provided to the practitioner stored in any convenient and suitable ways that preserve their operability, sterility and/or utility. The components are typically contained in suitable packaging material(s). As employed herein, the phrase “packaging material” refers to one or more physical structures used to house the contents of the kit, such as inventive components and the like. The packaging material is constructed by well known methods, preferably to provide a sterile, contaminant-free environment. The packaging materials employed in the kit are those customarily utilized for medical devices and instruments. As used herein, the term “package” refers to a suitable solid matrix or material such as glass, plastic, paper, foil, and the like, capable of holding the individual kit components. Thus, for example, a package can be a plastic wrap used to contain components of the inventive subject matter. The packaging material generally has an external label which indicates the contents and/or purpose of the kit and/or its components.

By using the subject matter apparatus and methods, a number of applications have been demonstrated including: (1) improved preservation of the explanted donor heart by delivering a continuous flow of fresh preservation solution directly into vital areas of the heart; (2) extended duration of preservation of the explanted donor heart by circulating fresh preservation solution continuously into critical portions and vessels of the organ; 3) improved preservation of the explanted organ by accomplishing the aforementioned in a sterile and reliable manner throughout the transportation of the donor organ to the recipient; and 4) improved preservation of the explanted donor heart by extending the viable time for explanted hearts which improves clinical outcomes in organ recipients.

### EXAMPLE

The following example is provided to better illustrate the claimed subject matter and is not to be interpreted as limiting the scope of the subject matter. To the extent that specific materials are mentioned, it is merely for purposes of illustration and is not intended to limit the subject matter. One skilled in the art may develop equivalent means or reactants without the exercise of inventive capacity and without departing from the scope of the subject matter.

In an effort to verify the function of optimal positioning of the donor heart which is most conducive towards maximum perfusion efficacy and dispersion of perfusate into critical portions and vessels of the heart, a dyed solution, parallel in consistency and viscosity with current preservation solutions, was used to perfuse a pig heart using the Cardioplegia apparatus and methods. Following adequate perfusion consistent with the methods disclosed in the subject matter, a cross section at the apex of the heart was removed to examine the functionality of the aortic valve and to evaluate the conditions in which the valve would no longer be functional, and to observe the extent of dispersion of the dyed solution to the arteries. The cross section of the perfused heart revealed that the aorta must be positioned relatively strait and extended to ensure the flow of preservation solution through the coronary arteries. Furthermore, the sample revealed that the coronaries, as well and the micro-vasculature of the heart, were comprehensively perfused using the Cardioplegia device as evidenced by the blue-dye stained arteries. Please note, the veins were not stained because the apex of the heart was removed and the dyed solution did not have an opportunity to circulate the veins.

The foregoing description and example of the subject matter known to the applicant at the time of filing this application has been presented and is intended for the purposes of illustration and description. The present description and example is not intended to be exhaustive nor limit the subject matter to the precise form disclosed and many modifications and variations are possible in light of the above teachings. The embodiment described serves to explain the principles of the subject matter and its practical application and to enable others skilled in the art to utilize the subject matter in various embodiments and with various modifications as are suited to the particular use contemplated. Therefore, it is intended that the subject matter disclosed herein not be limited to the particular embodiment discloseds.

While particular embodiments of the present subject matter have been shown and described, it will be obvious to those skilled in the art that, based upon the teachings herein, changes and modifications may be made without departing from this subject matter and its broader aspects and, therefore, the appended claims are to encompass within their scope all such changes and modifications as are within the true spirit and scope of this subject matter. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.).

What is claimed is:

1. A heart preservation apparatus comprising:
a container for adjustably cradling a heart;
a removable top for sealing the container;
a preservation solution source containing preservation solution;
a cooling coil for regulating preservation solution temperature;
a waste bag for collecting preservation solution;
a cannula extending through the removable top and to which a heart may be attached; and
a pressure source for driving the preservation solution through the heart preservation apparatus,
wherein the apparatus is configured such that, in operation, the preservation solution is routed from the preservation solution source through the cooling coil to the cannula, where preservation solution is introduced and flowed through the heart, and waste preservation solution is siphoned to the waste bag.

2. The apparatus according to claim 1, further comprising a filter between the cooling coil and cannula for filtration.

3. The apparatus according to claim 1, further comprising a clamping device between the preservation solution source and cooling coil for regulating the flow of preservation solution.

4. The apparatus according to claim 1, further comprising a clamping device between the container and waste bag for regulating the flow of preservation solution.

5. The apparatus according to claim 1, further comprising a de-airing chamber associated with the cannula for collecting air.

6. The apparatus according to claim 5, further comprising a de-airing valve attached to the de-airing chamber for releasing air.

7. The apparatus according to claim 6, further comprising a clamping device attached to the de-airing valve for regulating the release of air.

8. The apparatus according to claim 1, further comprising at least one sterile bag encapsulating the container.

9. The apparatus according to claim 1, wherein the container has an adjustable cradle.

10. The apparatus according to claim 9, wherein the adjustable cradle may be manipulated vertically by a repositioning device.

11. The apparatus according to claim 1, wherein the cannula contains at least one flange at the inferior end for attachment of the organ.

12. The apparatus according to claim 1, further comprising a pressure regulator to control the flow of preservation solution.

13. The apparatus according to claim 1, further comprising an insulated container for housing the organ preservation apparatus.

14. The apparatus according to claim 1, wherein the pressure source comprises a pressure vacuum system.

15. An apparatus for heart preservation comprising:
a container for adjustably cradling a heart;
a removable top for sealing the container;
a preservation solution source containing preservation solution;
a cooling coil for regulating preservation solution temperature;
a waste bag for collecting preservation solution;
a cannula extending through the removable top and to which a heart may be attached; and
a pressure vacuum source for driving the preservation solution through the heart preservation apparatus,
wherein the apparatus is configured such that, in operation, the pressure vaccum system initiates the flow of preservation solution from the preservation solution source through the cooling coil to the cannula, where preservation solution is introduced and flowed through the heart, and waste preservation solution is siphoned to the waste bag.

16. A method for heart preservation comprising:
providing a heart preservation apparatus comprising:
a container for adjustably cradling a heart;
a removable top for sealing the container;
a preservation solution source containing preservation solution;
a cooling coil for regulating preservation solution temperature;
a waste bag for collecting preservation solution;
a cannula extending through the removable top and to which a heart may be attached; and
a pressure source for driving the preservation solution through the heart preservation apparatus.
attaching the heart to the inferior end of the cannula;
adjusting the heart within the container; and
flowing preservation solution through the heart.

17. The method of claim 16, further comprising adjusting the heart in the container with a repositioning device.

18. The method of claim 16, further comprising regulating the flow of preservation solution with a pressure regulator.

19. The method of claim 16, wherein the flow of preservation solution is operated intermittently.

20. The method of claim 16, wherein the flow of preservation solution is operated continuously.

21. The method of claim 16, further comprising encapsulating the compartment in at least one sterile bag.

22. The method of claim 16, wherein the apparatus further comprises an insulated container for housing the organ preservation apparatus.

23. The method of claim 16, further comprising collecting waste preservation solution in a waste bag.

24. A method for heart preservation comprising:
providing an heart preservation apparatus comprising:
a container for adjustably cradling a heart;
a removable top for sealing the container;
a preservation solution source containing preservation solution;
a cooling coil for regulating preservation solution temperature;
a waste bag for collecting preservation solution;
a cannula extending through the removable top and to which a heart may be attached; and
a pressure vacuum source for driving the preservation solution through the heart preservation apparatus,
attaching the heart to the inferior end of the cannula;
adjusting the heart within the container; and
flowing preservation solution from the preservation solution source through the cooling coil to the cannula, where preservation solution is introduced and flowed through the heart.

25. A kit for heart preservation comprising:
a container for adjustably cradling the heart;
a removable top for sealing the container;
a preservation solution source containing preservation solution;
a cooling coil for regulating preservation solution temperature;
a waste bag for collecting waste preservation solution; and
a cannula extending through the removable top and to which a heart may be attached.

26. The kit of claim 24, further comprising a pressure source for driving preservation solution through the heart.
